(19) United States
(12) Patent Application Publication
(10) Pub. No.: US 2007/0230416 A1
(43) Pub. Date: Oct. 4, 2007

(54) Voice frame communication in wireless communication system

(76) Inventors: John M. Harris, Chicago, IL (US); Hao Bi, Wheeling, IL (US); Fan Wang, Vernon Hills, IL (US); Michael Mao Wang, San Diego, CA (US)

Correspondence Address: MOTOROLA INC, 600 NORTH US HIGHWAY 45, ROOM AS437, LIBERTYVILLE, IL, 60048-5343, US

(21) Appl. No.: 11/395,008

(22) Filed: Mar. 31, 2006

(51) Int. Cl. H04Q 7/24

(52) U.S. Cl. 370/338; 370/329

(57) ABSTRACT

A wireless communication system where voice frames are transmitted in sub-frames, wherein multiple sub-frames constitute a single radio frame, at least one of the sub-frames not having a negative acknowledgement associated therewith, including at a radio access network (120), decoding a voice frame in sub-frame of a received radio frame, the sub-frame having a negative acknowledgement associated therewith, transmitting, from the radio access network, the voice frame in a sub-frame of an other radio frame, the sub-frame of the other radio frame not having an negative acknowledgement associated therewith.

### FIELD OF THE DISCLOSURE

The present disclosure relates generally to wireless communications and more particularly to methods and apparatuses for communicating voice frames within wireless communication systems using acknowledgement feedback and/or negative acknowledgement (ACK/NAK) feedback.

### BACKGROUND

Generally, in wireless communication systems, signal strength varies and channel capacity fluctuates as the mobile communication terminal moves in and out of signal fading environments. Exemplary wireless communication systems susceptible to fading include code division multiple access (CDMA) 2000 and wideband CDMA (W-CDMA) among other mobile communications systems. The capacity of wireless communication systems can be improved by mitigating fading.

Voice traffic is typically between approximately 40% and approximately 90% of the radio frequency (RF) load in wireless communication systems. Improvement in voice capacity will thus have an impact on system capacity and will be beneficial to the growth of wireless communication systems. In CDMA systems, there are typically two principal limiting factors to voice capacity. One is the RF capacity and the other is the Walsh code space. To some extent, depending on system load, a tradeoff can be made between these factors. For example, there are two radio configurations, RC3 and RC4, for the CDMA 2000 forward link. A voice call in RC4 consumes one-half the Walsh code space than that consumed in RC3, but RC4 requires approximately 1.15 dB better signal-to-noise ratio (SNR) quality than in RC3 for the same frame erasure ratio (FER).

Wireless communication devices use a voice-coder (vocoder) to code audio information prior to transmission over the radio link. With the development of the Selectable Mode Vocoder (SMV) or the similar 4G Vocoder (4GV), RF efficiency may also be traded with voice quality or voice activity. SMV contains a set of modes with a different mix of full rate, half rate, quarter rate and eighth rate frames. The voice quality and RF load generated by a particular SMV mode depends on the percentages of each type of frame. The higher the percentage of full rate frames, the better the voice quality, but the higher the RF load generated. There is also a half-rate maximum mode that limits the voice frame to not higher than half-rate. The half-rate maximum mode was originally designed to reduce network congestion. The voice quality of half-rate maximum mode is satisfactory for some push-to-talk applications.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates a wireless communication system.

FIG. 2 illustrates a wireless communication terminal.

FIG. 3 illustrates a radio frame having sub-frames for transmitting voice frames.

FIG. 4 illustrates uplink and downlink radio frame sequences.

FIG. 5 illustrates an exemplary base transceiver station.

### DETAILED DESCRIPTION

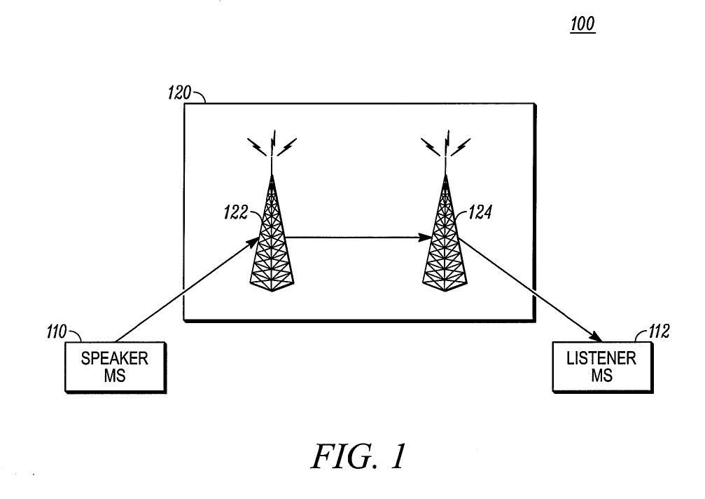

In the wireless communication system 100 of FIG. 1, first and second wireless communication terminals 110, 112 communicate with each other over an access network 120. In some embodiments, the access network constitutes part of a public land mobile network (PLMN) or other communication system. A PLMN generally comprises a core network communicably coupled to one or more access networks. In FIG. 1, each access network includes a controller (not shown) communicably coupled to one or more cellular area transceivers 122, 124 that communicate with user terminals in the corresponding cells, for example, mobile terminals 110, 112 in FIG. 1. The core network generally includes a mobile switching center (MSC) communicably coupled to a location register, for example, to a visitor location register (VLR) and/or a home location register (HLR). In a PLMN, the mobile switching center is typically communicably coupled to a public switched telephone network (PSTN), for example, by a gateway mobile switching center. The access network controller is also typically communicably coupled to other networks, for example, to a packet network. A detailed illustration and description of core and access network components are not included since these entities are generally well known by those having ordinary skill in the art.

Extant cellular communication networks include 2nd and 2.5 Generation 3GPP GSM networks, 3GPP WCDMA networks, and 3GPP2 CDMA communication networks among other existing and future generation cellular communication networks. Future generation networks include the developing Universal Mobile Telecommunications System (UMTS) networks and Evolved Universal Terrestrial Radio Access (E-UTRA) networks. The communication network may also be of a type that implements frequency-domain oriented multi-carrier transmission techniques, such as Frequency Division Multiple Access (OFDM), DFT-Spread-OFDM, IFDMA, etc. Other communication systems to which the disclosure pertains include local area network access points, for example, IEEE 802.xx protocol access points, and other access points providing connectivity between communication devices and network entities.

Generally, in some communications systems, multiple core network entities share the same radio access network or networks and the corresponding radio spectrum. For example, different service providers may operate different core networks identified by corresponding core network identities, for example, by a corresponding Public Land Mobile Network (PLMN) identity (ID), sharing one or more common access networks. In FIG. 1, the access network generally refers to multiple access networks since a mobile terminal may communicate with other terminals across one or more access networks.

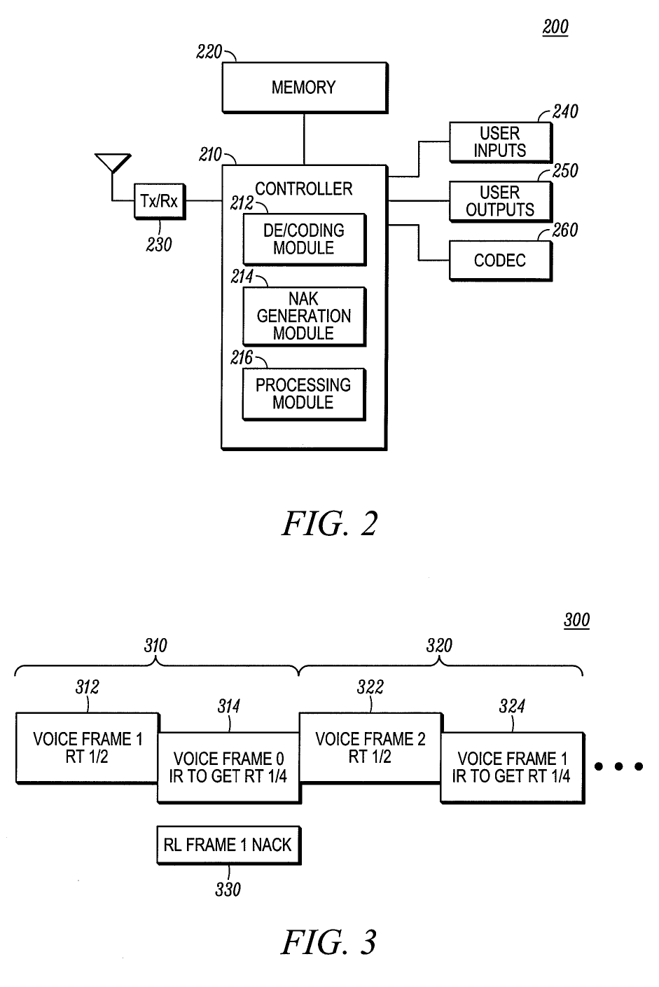

FIG. 2 illustrates a wireless communication terminal 200 comprising generally a controller 210 communicably coupled to memory 220, which stores programmed code for execution by the controller. The controller may be embodied as a digital signal processor (DSP) or other processor. The terminal 200 includes a radio transceiver 230 for transmitting and receiving information over a radio link. User inputs 240 and user outputs 250 coupled to the controller provide a user interface including, for example, an audio microphone, a keypad, a video display, and audio outputs among other inputs and outputs. The terminal also includes an audio codec 260 for coding and decoding voice data. While the codec is illustrated separately, it may be implemented by software executed by the controller or DSP.

FIG. 3 illustrates a sequence 300 of radio frames comprising multiple sub-frames. Particularly, the illustrated radio frame 310 includes first and second sub-frames 312 and 314, and radio frame 320 includes sub-frames 322 and 324. In other embodiments, each radio frame may include more sub-frames. In one embodiment wherein multiple sub-frames constitute a single radio frame, some of the sub-frames have a negative acknowledgement associated therewith and at least one of the sub-frames does not have a negative acknowledgement associated therewith.

In some wireless communication systems, voice frames are transmitted in sub-frames of the radio frames. In one exemplary radio frame structure, some sub-frames are reserved for transmitting specified voice frames and other sub-frames are reserved for re-transmitting previously transmitted voice frames, for example, in the event that that the recipient does not receive a voice frame or is unable to decode it properly. Proper decoding may be confirmed by the recipient using cyclic redundancy checking (CRC) or other means. In FIG. 2, the decoding and CRC processing is performed by the codec 260. The receipt of a NAK prompts the transmitting entity to re-transmit the date, for example, voice frame, in the sub-frame with which the NAK is associated. Alternatively, the recipient may send an acknowledgement (ACK) to the sender upon successfully decoding the received voice frame, wherein the absence of the ACK may prompt the re-transmission of the voice frame.

In one embodiment, generally, negative acknowledgements are associated with the sub-frames reserved for transmitting specific voice frames, but negative acknowledgements are not associated with the sub-frames reserved for re-transmission, at least for the last possible re-transmission. Where the sub-frame is reserved for the last re-transmission, a negative acknowledgement (NAK) is unnecessary since there are no other opportunities to re-transmit the voice frame.

In FIG. 3, sub-frame 312 of radio frame 310 is for transmitting “Voice Frame 1” and sub-frame 314 is for re-transmitting “Voice Frame 0”, which was transmitted in an earlier radio frame (not illustrated). In the illustrated embodiment, there is only a single re-transmission opportunity for each voice frame. In FIG. 3, a NAK is associated with the sub-frame 312 of radio frame 310 and sub-frame 322 of radio frame 320, as these frame are reserved for the first or at least not the last possible transmission of voice frames. NAK 330 is associated with sub-frame 312. In other words, the recipient of “Voice Frame 1” in sub-frame 312 sends NAK 330 if a re-transmission of “Voice Frame 1” is required. Similarly, there is a NAK associated with sub-frame 322, though the NAK is not illustrated in FIG. 3. In FIG. 3, a NAK is not associated with the sub-frames 314 and 324, which are reserved for re-transmission. In FIG. 3, “Voice Frame 0” is being re-transmitted in sub-frame 314 in response to a NAK sent earlier, and thus no further re-transmission of “Voice Frame 0” is permissible.

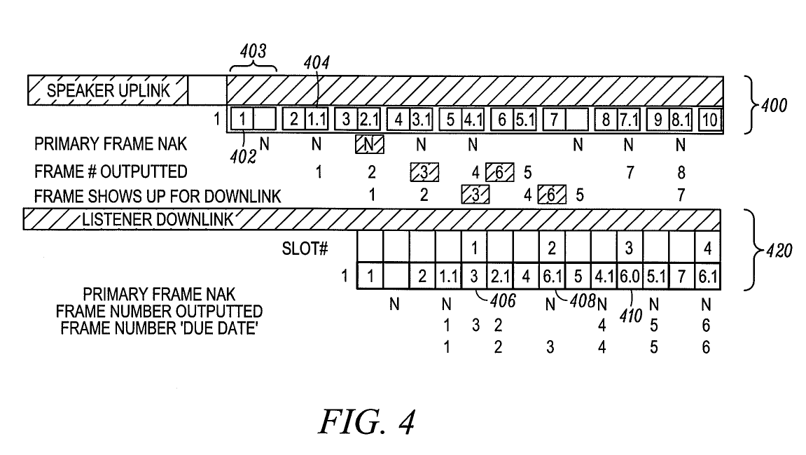

FIG. 4 illustrates a speaker radio frame sequence 400 and a listener downlink radio frame sequence 420. In FIG. 1, the uplink radio frames originate at the speaker MS 110 and are transmitted to the RAN 120, and the downlink radio frames are transmitted by the RAN to the listener MS 112. As noted, the uplink may be to a first RAN and the downlink may be from a second RAN in communication with the first RAN. In FIG. 4, each radio frame includes first and second sub-frames and each voice frame is retransmitted only once. The first sub-frame is for the initial voice frame transmission and the second sub-frame is for re-transmission. According to one exemplary embodiment, a NAK is associated with the first sub-frame, but not the second, re-transmission sub-frame.

In FIG. 4, each radio frame of the speaker uplink sequence 400 comprises first and second sub-frames. A voice frame “1” is transmitted by the speaker in a first sub-frame 402 of radio frame 403. The first voice frame is re-transmitted as frame “1.1” in the re-transmission sub-frame 404 of a subsequent radio frame in response to receipt of a NAK by the speaker MS. The voice frame “x.1” terminology indicates that the x voice frame is being transmitted in a sub-frame dedicated to re-transmission. The speaker MS also transmits voice frames “2”, “3”, “4”, “5” . . . in sub-frames of corresponding radio frames. Voice frames “2”, “3”, “4”, “5”, “7” and “8” are re-transmitted as voice frames “2.1”, “3.1”, “4.1”, “5.1”, “7.1” and “8.1” in corresponding re-transmission sub-frames in response to the receipt of negative acknowledgements.

In FIG. 4, the “Frame # Outputted” indicates the receipt of voice frames at the RAN from the speaker MS. Voice frames “1”, “2”, “3”, “4”, “5”, “7” and “8” are received upon re-transmission, as discussed above. The RAN receives voice frame 6 after the first transmission attempt of voice frame “6”. The “Frame Shows Up For Downlink” sequence indicates the availability of these voice frames for transmission by the receiving RAN or by another RAN on the downlink to a listener MS.

In FIG. 4, where each radio frame includes only two sub-frames and where voice frames are sent not more than twice, it is only necessary to send a NAK in association with the sub-frame reserved for the initial voice frame transmission. Particularly, as discussed, a NAK is only necessary if the voice frame is not received or properly decoded on the first transmission attempt, since a voice frame not received or properly decoded on a second transmission attempt will not be re-transmitted a third time.

In FIG. 4, on the listener downlink, voice frames 1”, “2”, “3”, “4”, “5” and “7” are transmitted in sub-frames of corresponding radio frames. On the listener downlink, voice frames “1”, “2”, “4” and “5” are re-transmitted in corresponding re-transmission frames on the downlink as “1.1”, “2.1”, “4.1” and “5.1”. On the listener downlink, the voice frame “3” in sub-frame 406 was transmitted and received successfully in the first instance, and thus it is unnecessary to retransmit voice frame “3” in sub-frame 408. As noted, the sub-frame 408 is otherwise reserved for the re-transmission of voice frame “3” if necessary.

In FIG. 4, voice frame “6” is available for transmission on the downlink during the time slot corresponding to the sub-frame 408 reserved for re-transmitting voice frame “3”. Since it is unnecessary to re-transmit voice frame “3”, it is possible to transmit voice frame “6” in downlink sub-frame 408. The sub-frame 408 does not have a NAK associated with it since it is reserved for re-transmission of a previously sent voice frame, namely the re-transmission of voice frame “3”. Transmitting voice frame “6” in the re-transmission frame for voice frame “3” has the effect of transmitting voice frame “6” earlier than when voice frame “6” is otherwise scheduled for transmission in sub-frame 410. In FIG. 4, voice frame “6” contains audio recorded three frames after the audio recorded for voice frame “3”.

Thus, generally, in a wireless communication system where voice frames are transmitted in sub-frames, wherein multiple sub-frames constitute a single radio frame and wherein at least one of the sub-frames does not have an associated negative acknowledgement (NAK), the radio access network successfully decodes a voice frame in a sub-frame having a negative acknowledgement associated therewith. For the case where the radio access network re-transmits the voice frame only once, the voice frame must be received successfully on a first transmission attempt for a re-transmission sub-frame to become available to transmit a voice frame in the first instance. Thereafter, the radio access network may transmit a voice frame in the re-transmission sub-frame of the other radio frame not having the NAK associated with it.

In another embodiment, the voice frame that is transmitted in the sub-frame not having an associated NAK is transmitted a second time, for example in a sub-frame having an associated NAK. In FIG. 4, for example, the voice frame “6” is first transmitted in sub-frame 408, which is reserved for the re-transmission of voice frame “3” in the event that the earlier transmission of voice frame “3” in frame 406 is not successfully received or decoded. Voice frame “6” is identified as “6.1” in sub-frame 408 since this sub-frame is a re-transmission sub-frame. Since sub-frame 408 is a re-transmission sub-frame, it does not have a NAK associated with it. In FIG. 4, after transmitting voice frame “6” in sub-frame 408, voice frame “6” is optionally re-transmitted, for example in its dedicated transmission sub-frame 410. In some embodiments, it is desirable to re-transmit the voice frame “6” since sub-frame 408, in which voice frame “6” is first transmitted, does not have a NAK associated with it.

In FIG. 4, there is some delay between the time the “Frame # is Outputted” and the time that the “Frame Shows Up For Downlink”. This delay is generally attributable to some processing associating with formatting, coding and possibly modulating the signal for transmission on the downlink. In some embodiments, there may also be some delay associated with communicating the voice frame data received at the uplink base station to a downlink base station within the same RAN or to a downlink base station in another RAN.

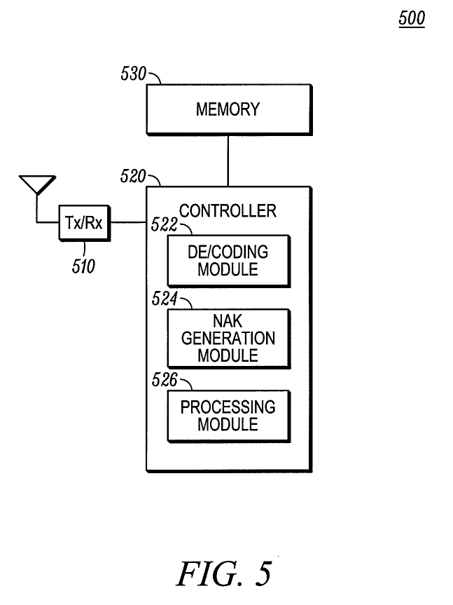

In FIG. 5, a base transceiver station 500 generally comprises a radio transceiver 510 communicably coupled to a processor 520 having memory associated therewith. The exemplary processor is a digital processor that operates under control of programming stored in memory. The access network base station transceiver 510 receives uplink voice frames in an uplink radio frame sequence, wherein the uplink voice frames are decoded by a decoding module 522. A NAK generation module 524 generates a NAK if the voice frame data in any sub-frame is not properly received or decoded, and the NAK is transmitted by the transceiver 510 to the sender. A processing module 526 performs any processing of the voice frames that may be required before the voice frames are coded and available for transmission on the downlink. For example, one or more voice frames may be situated in corresponding sub-frames otherwise reserved for re-transmission of a previously transmitted voice frame, as discussed above. Coding occurs in the coding module 522, which may also be part of the processor, as is known generally by those having ordinary skill in the art. As noted above, generally, there may be inter-communication between neighboring base stations and/or radio access networks between the uplink and downlink transmission of voice frames. The de-coding, NAK, processing and other modules are typically software implemented processor configurations, though in other embodiments these modules may be embodied by equivalent hardware.

In FIG. 2, the wireless communication terminal controller 210 includes a de/coding module 212 for decoding voice frames received in sub-frames of a radio frame received on a downlink, as discussed above. The coding module also codes voice frames for transmission on an uplink. The controller also includes a processing module 216 and a modulator that functions generally as discussed above in connection with the base station.

In accordance with one aspect of the disclosure, the wireless communication terminal receives a voice frame in a sub-frame of a first radio frame, wherein the sub-frame of the first radio frame does not have a negative acknowledgement associated therewith, and the wireless communication terminal receives another copy of the same voice frame in a sub-frame of a second radio frame received after receiving the first radio frame. In one embodiment, the sub-frame of the first radio frame does not have a negative acknowledgment associated therewith, and the sub-frame of the second radio frame has a negative acknowledgment associated therewith.

While the present disclosure and the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication system where voice frames are transmitted in sub-frames, wherein multiple sub-frames constitute a single radio frame, at least one of the sub-frames not having a negative acknowledgement associated therewith, the method comprising:
at a radio access network, successfully decoding a voice frame in sub-frame of a received radio frame, the sub-frame having a negative acknowledgement associated therewith;
transmitting, from the radio access network, the voice frame in a sub-frame of an other radio frame, the sub-frame of the other radio frame not having an negative acknowledgement associated therewith.

2. The method of claim 1,
receiving the voice frame in a sub-frame of the received radio frame wherein the sub-frame of the received radio frame is designated for a first transmission of the voice frame,
wherein the voice frame in the sub-frame of the other radio frame is designated for re-transmission of a different voice frame.

3. The method of claim 1,
transmitting the voice frame a second time in a sub-frame of a radio frame transmitted after the other radio frame.

4. The method of claim 1, the voice frame contains audio recorded three frames after the other voice frame.

5. A radio access network in a wireless communication system, the radio access network comprising:
a transceiver, the transceiver receiving a voice frame in a sub-frame of a radio frame;
a controller communicably coupled to the transceiver,
the transceiver operable to transmit the voice frame in a sub-frame otherwise reserved for re-transmission of another voice frame,
the transceiver operable to re-transmit the voice frame in a sub-frame otherwise reserved for an initial transmission of a voice frame.

6. The radio access network of claim 5,
the transceiver operable to re-transmit the voice frame in a sub-frame not having a negative acknowledgement associated therewith.

7. The radio access network of claim 5,
the transceiver operable to transmit the voice frame in a sub-frame not having a negative acknowledgement associated therewith,
the transceiver operable to re-transmit the voice frame in a sub-frame having a negative acknowledgement associated therewith.

8. A method in a wireless communication terminal, the method comprising:
receiving a voice frame in a sub-frame of a first radio frame, the sub-frame of the first radio frame not having a negative acknowledgement associated therewith;
receiving another copy of the voice frame in a sub-frame of a second radio frame received after receiving the first radio frame, the sub-frame of the second radio frame having a negative acknowledgment associated therewith.

9. A wireless communication terminal, comprising:
a transceiver;
a controller communicably coupled to the transceiver,
the controller including a module for decoding voice frames received in sub-frames of a radio frame,
the transceiver receiving a first voice frame in a sub-frame of a first radio frame, the first sub-frame not having a negative acknowledgement associated therewith,
the transceiver receiving a second copy of the voice frame in a sub-frame of a second radio frame,
the sub-frame of the second radio frame having a negative acknowledgment associated therewith.
